(19) United States
(12) Patent Application Publication
(10) Pub. No.: US 2016/0227539 A1
(43) Pub. Date: Aug. 4, 2016

(54) Frequency Resource And/Or Modulation & Coding Scheme Indicator For Machine Type Communication Device

(71) Applicants: Sigen Ye, Whitehouse Station, NJ (US); Shin Horng Wong, Chippenham (GB)

(72) Inventors: Sigen Ye, Whitehouse Station, NJ (US); Shin Horng Wong, Chippenham (GB)

(73) Assignees: Alcatel-Lucent USA Inc., Murray Hill, NJ (US); Alcatel-Lucent Telecom Limited, Swindon (GB)

(21) Appl. No.: 15/007,460

(22) Filed: Jan. 27, 2016

Related U.S. Application Data
(60) Provisional application No. 62/110,445, filed on Jan. 30, 2015.

(51) Int. Cl. H04W 72/04

(52) U.S. Cl. CPC H04W 72/0453

(57) ABSTRACT

Methods are disclosed for efficient scheduling of frequency resources (for example, subband and/or PRB locations) and/or identification of Modulation & Coding Scheme (MCS) for a UE in a wireless communication system. The UE may comprise, without limitation, a Low Complexity Machine Type Communication (LC-MTC) device. Frequency resource allocations (e.g., subband and/or PRB) are selected from among one or more subsets of available resource allocations (i.e., fewer than the entirety of possible resource allocations) within a frequency space, which allows the resource allocations to be specified with a relatively small number of DCI bits.

### CROSS-REFERENCE TO RELATED APPLICATIONS

The present application claims priority to the U.S. provisional patent application identified as Ser. No. 62/110,445, filed on Jan. 30, 2015, and titled, “Frequency Resource and/or Modulation & Coding Scheme Indicator for Machine Type Communication Device,” the disclosure of which is incorporated by reference herein in its entirety.

### FIELD OF THE INVENTION

This application relates generally to communication systems, and, more particularly, to wireless communication systems.

### BACKGROUND OF THE INVENTION

Control signaling is necessary to support downlink and uplink transport channels. In Long Term Evolution (LTE) systems, transport blocks are carried in Physical Downlink Shared Channel (PDSCH) and Physical Uplink Shared Channel (PUSCH), and control signaling is utilized to support PDSCH and PUSCH. The control signaling for PDSCH enables User Equipment (UE) to successfully receive, demodulate, and decode the PDSCH, and the control signaling for PUSCH provides the scheduling information to UE to transmit PUSCH. Downlink Control Information (DCI) is transmitted through a Physical Downlink Control Channel (PDCCH) or an Enhanced Physical Downlink Control Channel (EPDCCH). DCI for PDSCH or PUSCH includes information about the resource allocation (the set of physical resource blocks (PRBs) containing the PDSCH or PUSCH), modulation and coding scheme (MCS), and information related to the Hybrid Automatic Repeat reQuest (ARQ). A PRB includes a number of subcarriers by a number of symbols. In LTE, a PRB is twelve (12) subcarriers by seven (7) OFDM symbols, which is eighty-four (84) modulation symbols.

A Machine Type Communication (MTC) device is a User Equipment (UE) that is used by a machine for specific application. For example, a MTC device could be associated with a water meter, electricity meter, or the like, and utilized to report usage measured by the meter. For instance, a MTC device could be a part of a health monitor and used to report a parameter or status of the health monitor. In LTE Rel-12, a Work Item (WI) on Low Complexity MTC (LC-MTC) UE was concluded where the complexity (cost) of the MTC UE was reduced by approximately fifty percent (50%). In LTE Rel-13, another WI was agreed to further reduce the complexity of MTC UE, to enhance the coverage and improve the power consumption of MTC UE.

One of the complexity reduction techniques is to reduce the Radio Frequency (RF) bandwidth of the LC-MTC UE to 1.4 MHz (operating with 6 PRBs, where a PRB is a unit of resource allocation in the frequency domain). Herein, the term LC-MTC UE refers to MTC UE operating in 1.4 MHz bandwidth. The LC-MTC UE is expected to operate in any system bandwidth and shall be able to co-exist with legacy UEs. It is also expected that LC-MTC UE can retune its frequency to operate in different (1.4 MHz) sub-bands within the (larger) system bandwidth to allow frequency multiplexing among LC-MTC UE and also with legacy UE.

For coverage enhancement aspect of this WI, the main technique is repetition of the physical channel transmission. The number of repetitions is expected to be high, which would have a significant impact to the spectral efficiency. For example, the term repetition may refer to a number of repetitions for a physical channel transmission, such as PDSCH or PUSCH. A different repetition level allows the MTC UE at different coverage levels to use a different number of repetitions.

In current system DCI carried by either PDCCH or EPDCCH is used to schedule frequency resources (for example, PRB locations) to UEs. DCI will continue to be used to schedule frequency resources for LC-MTC UE. Due to the restricted bandwidth in LC-MTC UE, in addition to PRB locations, the DCI would likely also need to indicate the subband used, or may indicate the Modulation & Coding Scheme (MCS), which will increase the DCI size. In 3GPP, to avoid increasing repetitions, it is suggested that the DCI size is kept as small as possible.

Accordingly, there is a need to reduce the DCI size in indicating frequency resources (e.g., subband and/or PRB locations) and/or MCS to LC-MTC UEs whilst maintaining flexibility for the network.

### SUMMARY OF THE INVENTION

This need is addressed and a technical advance is achieved in the art by a feature for efficient indication of frequency resources (subband and/or PRB) and/or MCS to UEs, including, without limitation, LC-MTC UEs.

According to embodiments described and provided herein, frequency resource allocations (e.g., subband and/or PRB) are selected from among one or more semi-statically configured subsets (i.e., fewer than the entirety of possible allocations) within a frequency space, which allows the resource allocations to be specified with a relatively small number of DCI bits (e.g., one or two bits). In such manner, DCI size is reduced relative to that which would be needed to specify resources from among all possible allocations in the frequency space. Advantageously, the Modulation & Coding Scheme (MCS) may similarly be selected from among a relative few subsets and specified in a small number of DCI bits.

### BRIEF DESCRIPTION OF THE DRAWINGS

The foregoing and other advantages of the invention will become apparent upon reading the following detailed description and upon reference to the drawings in which:

FIG. 1 illustrates an example configuration of subband locations within a frequency space, which allows a subband to be specified with a small number of DCI bits according to an embodiment of the present invention;

FIG. 2 illustrates an example configuration of PRB locations within a subband, from which a PRB allocation may be specified with a small DCI indication according to an embodiment of the present invention;

FIG. 3 illustrates an example configuration of subband locations within a frequency space, wherein a subband includes a single PRB and wherein a PRB allocation corresponding to the subband allocation may be specified with a small DCI indication according to an embodiment of the present invention;

FIG. 4 illustrates a portion of an Evolved Packet System (EPS) in which embodiments of the invention may be deployed; and

FIG. 5 depicts a high-level block diagram of a computer suitable for use in performing the operations and methodology described herein.

### DESCRIPTION OF THE PREFERRED EMBODIMENT(S)

According to embodiments described and provided herein, frequency resource allocations (e.g., subband and/or PRB) are selected from among one or more semi-statically configured subsets (i.e., fewer than the entirety of possible allocations) within a frequency space, which allows the resource allocations to be specified with a relatively small number of DCI bits (e.g., one or two bits). In such manner, DCI size is reduced relative to that which would be needed to specify resources from among all possible allocations in the frequency space.

FIG. 1 illustrates an example configuration of subband locations within a frequency space 100 for different UEs (“UE1” and “UE2”). The frequency space 100 contains a plurality (as shown, 15) of frequency elements 102 from which possible PRB locations and subband locations may be identified. In one example, the frequency space 100 of FIG. 1 defines a 3MHz system bandwidth containing 15 frequency elements 102, corresponding to 15 possible PRB locations, and the UEs define LC-MTC UEs (requiring a subband with 6 contiguous frequency elements 102, corresponding to 6 PRB locations). In this example, therefore, the frequency space 100 has the capacity for 10 possible subbands, requiring 4 bits to specify a particular subband allocation from among the 10 possibilities. [Given 15 PRBs contiguous to one another, there are 10 possible subband of 6 PRBs contiguous to each other; and 4 bits, (indicating 2̂4=16 possibilities) are needed to specify one of the 10 subbands. (3 bits (indicating 2̂9=8 possibilities) are not enough to specify one of the 10 subbands).]

However, according to principles of the present invention, the frequency space is semi-statically configured into one or more subsets of available subband locations (i.e., fewer than the capacity of possible subbands within the frequency space), such that a subband allocation can be specified with fewer bits. In particular, the frequency space for UE1 is configured into three available subbands 104, 106, 108; and the frequency space for UE2 is configured into two available subbands 110, 112, much fewer than the entirety (10) of possible subbands within the frequency space 100. Each of the available subband locations consists of 6 contiguous frequency elements 102, corresponding to 6 PRB locations for the respective UEs. In a configuration defining only three available subband locations for UE1 (i.e., subbands 104, 106, 108) and 2 available subband locations for UE2 (i.e., subbands 110, 112), only 2 bits (indicating 2̂2=4 possibilities) are needed to specify respective subband allocations for UE1 and UE2. It is noted, a configuration defining up to 4 available subband locations could be used for UE1 and/or UE2 while still permitting the subband allocation to be specified with 2 bits; whereas a configuration defining two or fewer available allocations can be specified with 1 bit (thus, in the present example, resource allocation for UE2, having only two possible subbands, could have been specified with 1 bit).

Alternatively, a special case is that the subband allocation can be broadcast in the System Information Block (SIB) which means that all UEs would have the same subband allocations.

In another embodiment, different repetition levels have different subsets of subband allocation.

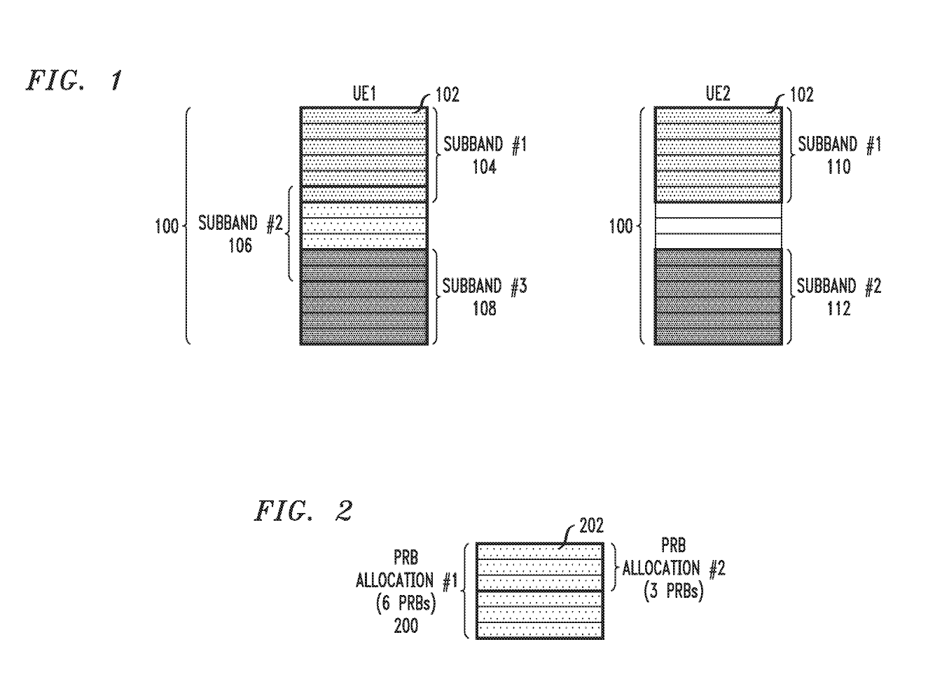

Turning now to FIG. 2, there is shown an example configuration of PRB locations within a frequency space 200 defining a subband. In particular, the frequency space 200 includes 6 frequency elements 202, corresponding to an example subband of an LC-MTC UE. According to principles of the present invention, the frequency space 200 is semi-statically configured into one or more available subsets, such that the PRB allocations can be specified with fewer bits. In particular, the frequency space of FIG. 2 is configured into two available PRB allocations, such that the PRB allocation may be specified with only 1 bit. As shown, one of the available PRB allocations (#1) occupies 6 frequency elements 202 (i.e., the entire subband) and the other available PRB allocation (#2) occupies the upper three frequency elements 202 of the subband. This configuration can be UE-specific (RRC signaled) or broadcast in the cell. In another embodiment, different repetitions have different subsets of PRB allocation. In another embodiment, the network configures a number of possible MCS candidates for the UE and the DCI bits point to a specified one of the MCS within this said subset. This subset of MCS can be signaled via RRC or broadcast in the SIB. Given a subset of possible MCS, the DCI bits indicate the particular MCS to utilize. A special case is that the network configures a single MCS, and no bit is necessary in DCI to indicate the MCS. This can be useful for LC-MTC UE in coverage enhancement mode, where the lowest MCS can be configured. In another embodiment, different repetitions have different subsets of MCS.

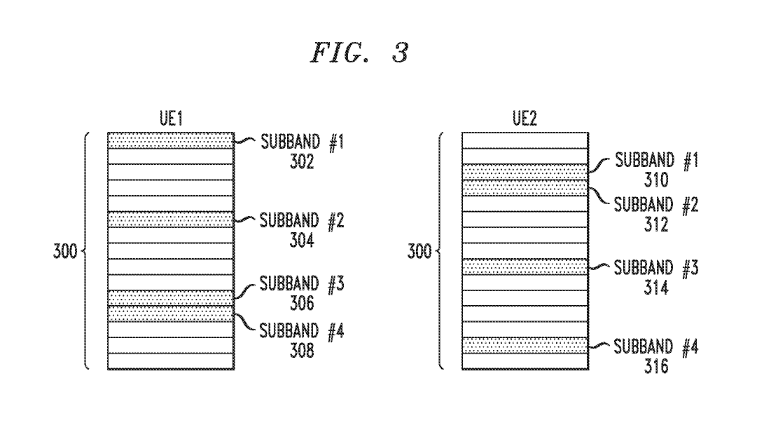

FIG. 3 illustrates yet another example configuration of subband locations within a frequency space 300 for different UEs (“UE1” and “UE2”). As in FIG. 1, the frequency space 300 contains a plurality (as shown, 15) of frequency elements from which possible PRB locations and subband locations may be identified. In one example, the frequency space 300 of FIG. 3 defines a 3MHz system bandwidth containing 15 frequency elements, corresponding to 15 possible PRB locations. In the example of FIG. 3, however, the UEs support a smaller bandwidth than LC-MTC UEs (i.e., requiring fewer than 6 PRB locations) in order to further reduce the cost and saving power. In a special case, one subband can correspond to a single PRB.

In the example of FIG. 3 where one subband corresponds to a single PRB, the frequency space 300 has the capacity for 15 possible subbands/PRBs, and 4 bits (indicating 2̂4=16 possibilities) would be needed to specify a particular subband/PRB allocation from among the 15 possibilities. [3 or fewer bits are not enough to specify one of the 15 possibilities.] However, according to principles of the present invention, the frequency space is semi-statically configured into one or more subsets of available subband/PRB locations (i.e., fewer than the capacity of possible subbands within the frequency space), such that a subband/PRB allocation can be specified with fewer bits. In particular, the frequency space for UE1 is configured into four available subbands 302, 304, 306, 308; and the frequency space for UE2 is also configured into four available subbands 310, 312, 314, 316, much fewer than the entirety (15) of possible subbands within the frequency space 300. Each of the available subband locations consists of a single frequency element, corresponding to a single PRB for the respective UEs. In a configuration defining four available subband locations for UE1 (i.e., subbands 302, 304, 306, 308) and four available subband locations for UE2 (i.e., subbands 310, 312, 314, 316), only 2 bits (indicating 2̂2=4 possibilities) are needed to specify respective subband/PRB allocations for UE1 and UE2.

As will be appreciated, providing semi-static configurations of subsets defining a limited number of possibilities maintains some flexibility for the network while reducing the number of signaling bits in the DCI. The principles may be used to specify frequency resource allocations (e.g., subband and/or PRB) and/or MCS for different UEs, including different types of UEs (e.g., without limitation, LC-MTC UEs) and UEs having different subband and/or PRB characteristics.

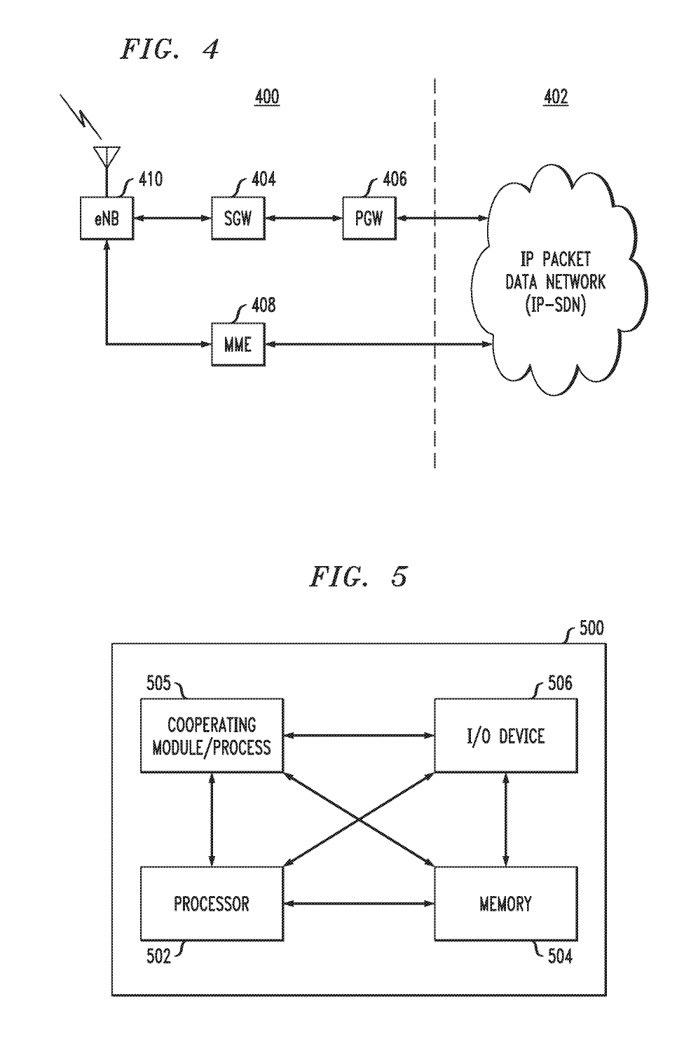

FIG. 4 illustrates a portion of an Evolved Packet System (EPS). The EPS includes an Internet Protocol (IP) Connectivity Access Network (IP-CAN) 400 and an IP Packet Data Network (IP-PDN) 402. Referring to FIG. 4, the IP-CAN 400 includes: a serving gateway (SGW) 404; a packet data network (PDN) gateway (PGW) 406; a mobility management entity (MME) 408, and an eNB 410. Although not shown, the IP-PDN 402 portion of the EPS may include application or proxy servers, media servers, email servers, etc.

Within the IP-CAN 400, the eNB 410 is part of what is referred to as an Evolved Universal Mobile Telecommunications System (UMTS) Terrestrial Radio Access Network (EUTRAN), and the portion of the IP-CAN 400 including the SGW 404, the PGW 406, and the MME 408 is referred to as an Evolved Packet Core (EPC). Although only a single eNB 410 is shown in FIG. 4, it should be understood that the EUTRAN may include any number of eNBs. Similarly, although only a single SGW, PGW and MME are shown in FIG. 4, it should be understood that the EPC may include any number of these core network elements.

The eNB 410 provides wireless resources and radio coverage for UEs (one shown, UE 412) which uses a reduced-size DCI, as described herein, to identify frequency resources (e.g., subband and/or PRB allocations) and/or Modulation & Coding Scheme (MCS). In one embodiment, UE 412 is a Low Complexity MTC device. For the purpose of clarity, only one UE 412 is illustrated in FIG. 4. However, any number of UEs may be connected (or attached) to the eNB 410. The eNB 410 is operatively coupled to the SGW 404 and the MME 408.

The SGW 404 routes and forwards user data packets, while also acting as the mobility anchor for the user plane during inter-eNB handovers of UEs. The SGW 404 also acts as the anchor for mobility between 3^{rd} Generation Partnership Project Long-Term Evolution (3GPP LTE) and other 3GPP technologies. For idle UEs, the SGW 404 terminates the downlink data path and triggers paging when downlink data arrives for UEs.

The PGW 406 provides connectivity between the UE 412 and the external packet data networks (e.g., the IP-PDN 402) by being the point of entry/exit of traffic for the UE 412. As is known, a given UE may have simultaneous connectivity with more than one PGW for accessing multiple PDNs.

The PGW 406 also performs policy enforcement, packet filtering for UEs, charging support, lawful interception and packet screening, each of which are well-known functions. The PGW 406 also acts as the anchor for mobility between 3GPP and non-3GPP technologies, such as Worldwide Interoperability for Microwave Access (WiMAX) and 3^{rd} Generation Partnership Project 2 (3GPP2 (code division multiple access (CDMA) 1× and Enhanced Voice Data Optimized (EvDO)). Still referring to FIG. 4, the eNB 410 is also operatively coupled to the MME 408.

The MME 408 is the control-node for the EUTRAN, and is responsible for idle mode UE paging and tagging procedures including retransmissions. Idle mode may be a mode where the UE has not been used in a threshold amount of time of, for example, 10 minutes, 30 minutes or more. The MME 408 is also responsible for choosing a particular SGW for a UE during initial attachment of the UE to the network, and during intra-LTE handover involving Core Network (CN) node relocation. The MME 408 authenticates UEs by interacting with a Home Subscriber Server (HSS), which is not shown in FIG. 4. Non Access Stratum (NAS) signaling terminates at the MME 408, and is responsible for generation and allocation of temporary identities for UEs. The MME 408 also checks the authorization of a UE to camp on a service provider's Public Land Mobile Network (PLMN), and enforces UE roaming restrictions. The MME 408 is the termination point in the network for ciphering/integrity protection for NAS signaling, and handles security key management.

The MME 408 also provides control plane functionality for mobility between LTE and 2G/3G access networks with the S3 interface from the SGSN (not shown) terminating at the MME 408. The MME 408 also terminates the S6a interface to the home HSS for roaming UEs.

FIG. 5 depicts a high-level block diagram of a computer suitable for use in performing the operations and methodology described herein. The computer 500 includes a processor 502 (e.g., a central processing unit (CPU) or other suitable processor(s)) and a memory 504 (e.g., random access memory (RAM), read only memory (ROM), and the like).

The computer 500 also may include a cooperating module/process 505. The cooperating process 505 can be loaded into memory 504 and executed by the processor 502 to implement functions as discussed herein and, thus, cooperating process 505 (including associated data structures) can be stored on a computer readable storage medium, e.g., RAM memory, magnetic or optical drive or diskette, and the like. The computer 500 also may include one or more input/output devices 506 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 500 depicted in FIG. 5 provides a general architecture and functionality suitable for implementing functional elements described herein or portions of functional elements described herein. For example, the computer 500 provides a general architecture and functionality suitable for implementing one or more of a UE, an eNB, SGW, MME, PGW, network element, and the like. For example, a processor of a UE can be configured to provide functional elements that implement in the UE functions as discussed herein.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of one or more of the methods described herein. The program storage devices may be non-transitory media, e.g., digital memories, magnetic storage media such as a magnetic disks or tapes, hard drives, or optically readable digital data storage media. In one or more embodiments, tangible medium excluding signals may include a set of instructions which when executed are operable to perform one or more of the descried methods. The provided embodiments are also intended to be embodied in computers programmed to perform said steps of methods described herein.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein, the term “semi-static” (referring to semi-static configurations of subsets for specifying resource allocations) shall be understood to mean a configuration that is static, or fixed, for a period of time, until such time as it may be reconfigured by the service provider/network operator and/or reconfigured according to software instructions.

The term “eNodeB” or “eNB” may be considered synonymous to, and may hereafter be occasionally referred to as a NodeB, base station, transceiver station, base transceiver station (BTS), etc., and describes a transceiver in communication with and providing wireless resources to users in a geographical coverage area. As discussed herein, eNBs may have all functionality associated with conventional, well-known base stations in addition to the capability and functionality to perform the methods discussed herein.

The term “user equipment” or “UE” as discussed herein, may be considered synonymous to, and may hereafter be occasionally referred to, as user, client, mobile unit, mobile station, mobile user, mobile, subscriber, user, remote station, access terminal, receiver, etc., and describes a remote user of wireless resources in a wireless communications network.

As discussed herein, uplink (or reverse link) transmissions refer to transmissions from user equipment (UE) to eNB (or network), whereas downlink (or forward link) transmissions refer to transmissions from eNB (or network) to UE.

According to example embodiments, the Packet Data Network Gateways (PGW), Serving Gateways (SGW), Mobility Management Entities (MME), UEs, eNBs, etc. may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

In more detail, for example, as discussed herein a MME, PGW and/or SGW may be any well-known gateway or other physical computer hardware system. The MME, PGW and/or SGW may include one or more processors, various interfaces, a computer readable medium, and (optionally) a display device. The one or more interfaces may be configured to transmit/receive (wireline or wirelessly) data signals via a data plane or interface to/from one or more other network elements (e.g., MME, PGW, SGW, eNBs, etc.); and to transmit/receive (wireline or wirelessly) controls signals via a control plane or interface to/from other network elements.

The MME, PGW and/or SGW may execute on one or more processors, various interfaces including one or more transmitters/receivers connected to one or more antennas, a computer readable medium, and (optionally) a display device. The one or more interfaces may be configured to transmit/receive (wireline and/or wirelessly) control signals via a control plane or interface.

The eNBs, as discussed herein, may also include one or more processors, various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more switches, gateways, MMEs, controllers, other eNBs, UEs, etc.

What is claimed is:

1. A method for transmitting a control information message to a receiving device, the method comprising:
configuring one or more subsets defining available resource allocations within a frequency space, wherein the available resource allocations are fewer than an entirety of possible resource allocations within the frequency space;
specifying one of the available resource allocations, yielding a specified resource allocation; and
transmitting a control information message to a receiving device indicating the specified resource allocation.

2. The method of claim 1, wherein the available resource allocations define available subband allocations within the frequency space, the method comprising:
specifying one of the available subband allocations, yielding a specified subband allocation; and
transmitting a control information message to a receiving device indicating the specified subband allocation.

3. The method of claim 2, wherein the available subband allocations comprise four or fewer unique subsets of frequency elements within the frequency space, wherein the control information message includes two or fewer bits indicating the specified subband allocation.

4. The method of claim 2, wherein the available resource allocations further define available physical resource block (PRB) allocations within a subband, the method comprising:
specifying one of the available PRB allocations within the specified subband, yielding a specified PRB allocation; and
transmitting a control information message to a receiving device indicating the specified PRB allocation within the specified subband.

5. The method of claim 2, wherein a subband corresponds to a single physical resource block (PRB).

6. The method of claim 4, wherein the available PRB allocations comprise two or fewer unique subsets of frequency elements within a specified subband of the frequency space, wherein the control information message includes one bit indicating the specified PRB allocation.

7. The method of claim 1, wherein the configuration of one or more subsets defining available resource allocations within a frequency space is different for different number of repetitions used for transmitting a physical channel.

8. The method of claim 1, wherein the configuration of one or more subsets defining available resource allocations within a frequency space is signaled to one or more receiving devices using one of: broadcast signaling and UE-specific signaling.

9. A method for transmitting a control information message to a receiving device, the method comprising:
configuring one or more Modulation & Coding Scheme (MCS) candidates;
specifying one of the MCS candidates, yielding a specified MCS; and
transmitting a control information message to the receiving device using the specified MCS.

10. Apparatus for transmitting a control information message to a receiving device, the apparatus comprising:
a memory; and
at least one processor configured to:
configure one or more subsets defining available resource allocations within a frequency space, wherein the available resource allocations are fewer than an entirety of possible resource allocations within the frequency space;
specify one of the available resource allocations, yielding a specified resource allocation; and
transmit a control information message to a receiving device indicating the specified resource allocation.
